(19) United States
(12) Patent Application Publication
(10) Pub. No.: US 2021/0331491 A1
(43) Pub. Date: Oct. 28, 2021

(54) PRINTING FLUID DRYER

(71) Applicant: HEWLETT-PACKARD DEVELOPMENT COMPANY, L.P., Spring, TX (US)

(72) Inventor: Alan JACQUES, San Diego, CA (US)

(21) Appl. No.: 16/605,522

(22) PCT Filed: Apr. 25, 2018
(86) PCT No.: PCT/US2018/029285

§ 371 Date: Oct. 16, 2019

(51) Int. Cl. B41J 11/00

(52) U.S. Cl. CPC B41J 11/00216; B41J 11/00214

(57) ABSTRACT

A system including: a web moving through the system, the web comprising media and a printing liquid; a microwave source to apply microwaves to the web and printing fluid; and a cage to reduce emission of microwaves from the system.

### BACKGROUND

Printing systems apply printing liquids to media to create printed materials. If the printed material is contacted before the printing liquid has dried, the printing liquid may smear and/or cause the printed materials to adhere to each other. In such cases, the printed materials may need to be reprinted to produce an acceptable product. This may consume additional time and resources, leading to user dissatisfaction.

### BRIEF DESCRIPTION OF THE DRAWINGS

The accompanying drawings illustrate various examples of the principles described herein and are a part of the specification. The illustrated examples do not limit the scope of the claims.

FIG. 1 shows an example of a system for drying printing fluid consistent with this specification.

FIG. 2 shows an example of a system for drying printing fluid consistent with this specification.

FIG. 3 shows an example of a system for drying printing fluid consistent with this specification.

FIG. 4 shows an example of a system for drying printing fluid consistent with this specification.

FIG. 5 shows an example of a system for drying printing fluid consistent with this specification.

Throughout the drawings, identical reference numbers designate similar, but not necessarily identical, elements. The figures are not necessarily to scale, and the size of some parts may be exaggerated or minimized to more clearly illustrate the example shown. The drawings provide examples and/or implementations consistent with the description. However, the description is not limited to the examples and/or implementations shown in the drawings.

### DETAILED DESCRIPTION

It is desirable that printing fluid applied to media be dry prior to stacking as sheets and/or wound into a roll. This prevents smearing of the printing fluid, transfer of the printing fluid, and adhesion of sequential layers by the printing fluid. Many printing systems include a dryer, a heater, and/or multiple dryers and heaters to avoid excessive drying time. Longer drying times can increase the path length in the printer to allow for drying. Longer drying time can reduce the throughput of a printer.

Heaters and dryers may increase the cost of printing systems. Heaters and dryers may consume a large fraction of the energy used by the printing system. Heater and dryers may occupy space in the printing system. Heaters and dryers may add additional mechanical complexity to a system.

This specification describes a number of systems to dry printing fluid on freshly printed media. The described implementations may be mixed and matched to meet the design goals of a system.

Microwave energy may be preferentially absorbed by water, for example, at around 2.45 gHz. Microwaves may also be used to energize water vapor at around 22 gHz, for example, to increase diffusion. Microwaves may have greater penetration than infrared (IR) sources for heating a web containing printing fluid. A microwave source may be located within a microwave transparent enclosure. The microwave transparent enclosure may be transparent to microwaves in a window, with the remainder of the enclosure reflective to microwaves, in order to focus the output towards a particular point and/or material (e.g., the printing fluid on the web). The microwave source may be located within an air-bearing. The microwave source may be located on either side of the web. The transparency of the web to the microwaves allows flexibility in placement of the microwave source.

The microwave source may be a magnetron. The microwave source may be a vacuum tube. The microwave source may be a solid state device, for example, a field-effect transistor (FET), a tunnel diode, a Gunn diodes, and/or an IMPATT diodes.

In an example, a drying module includes a microwave source, an IR source, and an ultraviolet source (UV). A system may include a plurality of such drying modules. The amounts of power provided to the sources in the respective modules may be optimized based on an amount of printing fluid in the portion of the web being dried. The amounts of power provided to the sources in the respective modules may be optimized to prioritize energy consumption, throughput, and/or other parameters.

An air-bearing provides localized airflow to support an object, for example, a printing web. Like a puck on an air hockey table, the object is supported by the flow of air. The air flow can provide very high levels of “stiffness” in the bearing, allowing control over the standoff between the object and the surface below. This control can also be used to provide close proximity between the bearing and the object, for example to control and/or increase radiant heat transfer. In an example, the gap height between the web and the air-bearing is kept smaller than 1 mm. The gap height may be less than a thickness of a boundary layer associated with the web. In an example, the gap height is designed to strip the boundary layer from the web and divert the material into a trap for collection.

A boundary layer builds up on a surface as material, such as solvent, evaporates. The molecules move out of the boundary layer in to the environment (bulk) for example, by diffusion. The base of the boundary layer may be able to hold an amount of evaporated solvent before becoming saturated and/or supersaturated. Once the base of the boundary layer becomes saturated, additional evaporation is slowed by solvent condensing back. Heating the boundary layer may increase the carrying capacity of the boundary layer, i.e., how much solvent the boundary layer contains before saturating. Heating may also increase the diffusion rate from the boundary layer. Heating may increase the evaporation rate of material into the boundary layer. However, the saturation concentration of material at the base of the boundary layer may limit the removal rate from the web. The solvent may be the most prevalent material to be extracted from a printing fluid. Other materials in the printing fluid beside the solvent may impact the rates of evaporation and diffusion.

In an example, the boundary layer is separated from the surface of the web. The replacement layer may be unsaturated with the solvent of the printing fluid and thus the rate of removal of solvent from the printing fluid is increased. In many mass transfer configurations, the transfer may be modeled as a first order function of the difference in concentration. Accordingly, the driving kinetics may be fastest at first contact when the amount of solvent on the web is greatest and the amount of solvent in the boundary layer is lowest. This driving potential decrease as the boundary layer forms and reaches a steady state determined by the diffusion kinetics out of the boundary layer into the bulk phase.

However, by flowing air counter to the motion of the web, the kinetics at the upstream side where the web “first” makes contact with the counter-flowing air are reduced because the boundary layer is contains some solvent. The benefit is increasing the gradient when the amount of solvent in the web is the lowest, i.e., at the end. By applying unsaturated counter flowing air, greater extraction efficacy may be achieved. The amounts of extractable material in the web may be lower after passing through a system where the air is flowed counter to the motion of the web. This use of counter flow air in the system also facilitates the use of an upstream trap to gather in the extracted material and avoid secondary deposition on the system and/or environment.

Among other examples, this specification describes a system including a web moving through the system, the web including media and a printing liquid; a microwave source to apply microwaves to the web and printing fluid; and a cage to reduce emission of microwaves from the system.

Among other examples, this specification also describes a system including: a web moving in a first direction; a support under the web, the support separated from the web by a gap, the gap having a height and a length; and a counter-current air flow along the length of the gap in a direction counter to the first direction.

This specification also describes a system which includes: a web moving in a first direction, the web including media and a printing liquid; a plurality of identical modules, each module including: a support located under the web, an area between the support and the web forming a gap with a height and length, wherein: the height being the separation of the support and the web, the length being in the first direction, and an air flow flowing the length of the gap, the air flow moving counter to the first direction; a microwave source to apply microwaves to the web; an ultraviolet (UV) source to apply ultraviolet light to the web; an infrared (IR) source to apply infrared light to the web; and a reduced-pressure trap on an upstream side of the gap of a first module of the plurality of modules, the trap collecting material released from the web.

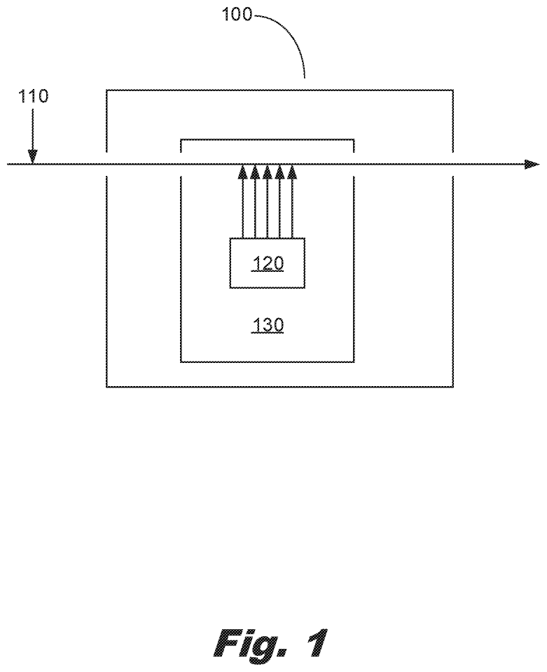

Turning now to the figures, FIG. 1 shows an example of a system (100) for drying printing fluid consistent with this specification. The system (100) includes a web (110) moving through the system (100), the web (110) including media and a printing liquid; a microwave source (120) to apply microwaves to the web (110) and printing fluid; and a cage (130) to reduce emission of microwaves from the system (100).

The system (100) is a system (100) for drying printing fluid. The system (100) may be part of a larger device, for example, a printer, a press, etc. The system (100) may receive recently printed material from a printhead, printer, etc. to dry. The system (100) may provide the material to another device for further processing, sorting, collating, binding, etc.

The web (110) includes media and printing fluid which has been applied to the media. The web (100) may include a belt to convey the media. The web may retain the media, for example, using a static electrical charge. The web may be the media and the printing fluid without additional support.

The microwave source (120) provides microwaves to energize the printing fluid of the web. The microwave source (120) may be a magnetron. The microwave source (120) may be a vacuum tube. The microwave source (120) may be a solid state device, for example, a field-effect transistor (FET), a tunnel diode, a Gunn diode, and/or an IMPATT diode. The microwave source may produce microwaves of 20 to 25 gHz and/or microwaves of 2 to 2.6 gHz.

The microwave source may be in a microwave transparent housing. The housing may be formed from a polymer, a glass, and/or other suitable material. The housing may be partially opaque to microwaves and partially transparent to microwaves. For example, the housing may be mostly opaque and include a window to allow the microwaves to be directed toward the web. The window may include a collimator and/or similar structure to reduce emission of microwaves from the system (100).

The microwave source (120) may be on either side of the web (110). Microwave sources (120) may be located on both sides of the web. In an example, the web is on an air-bearing with a reflective metal and/or metalized surface. The cage (130) reduces emission of microwaves from the system (100). The cage (130) may include microwave absorbing materials. The cage (130) may include microwave reflective materials. The cage (130) may enclose the microwave source (120). The cage (130) may include a reflector to redirect microwaves to the web (110). The cage may include multiple reflectors. The reflectors may include a metal sheet and/or film. The cage (130) includes openings to allow the web (110) to pass into the cage (130) and out of the cage (130). The height of an opening in the cage may be sized to reduce the passage of microwaves from the cage.

The system (100) may include rollers to redirect the web (110) as the web passes through the cage (130). Changing the direction of the web (110) may reduce microwave emissions from the cage (130). In an example, there is no straight line from the microwave source (120) out of the cage (130). For example, the web (110) may be redirected by a roller between two portions of the cage (130) and then redirected again once outside the cage (130). This may cause the web (110) to have a zig-zag and/or other non-straight travel path as viewed from the side.

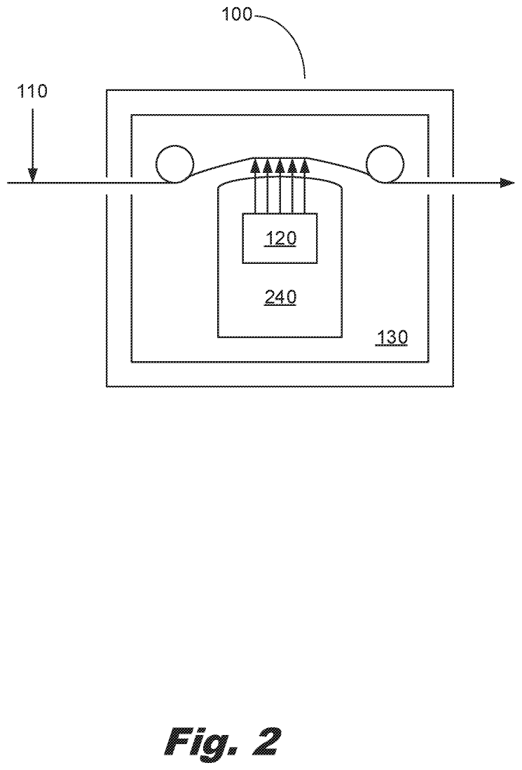

FIG. 2 shows an example of a system (100) for drying printing fluid consistent with this specification. A system (100) includes: a web (110) moving through the system (100), the web (110) including media and a printing liquid; a microwave source (120) to apply microwaves to the web (110) and printing fluid; a cage (130) to reduce emission of microwaves from the system (100); and a microwave-transparent air-bearing (240) encompassing the microwave source 120).

The microwave transparent air-bearing (240) may be static. The air-bearing (240) may rotate. The air-bearing (240) may have an array of vent holes of uniform size. The air-bearing (240) may have an array of vent holes of different sizes. For example, the air-holes towards the upstream side of the web may be smaller to reduce the air flow and pressure compared to the vent holes on the downstream side of the air-bearing in order to produce a pressure gradient on the air-bearing. The density of the vent holes may be non-uniform. In an example, a higher pressure may be produced toward the edges of the web to produce flow toward a center (width wise). A differences in vent holes may be used to provide a pressure gradient towards the upstream edge of the gap between the web (110) and the air bearing (240).

Placing the microwave source (120) in the microwave transparent air-bearing (240) allows the airflow into the air-bearing (240) to cool the microwave source (120). Similarly, the heat from the microwave source (120) helps to heat the air passing through the air-bearing (240) and supporting the web. This allows efficient use of the waste heat of the microwave source (120) to enhance drying of the printing fluid of the web (110).

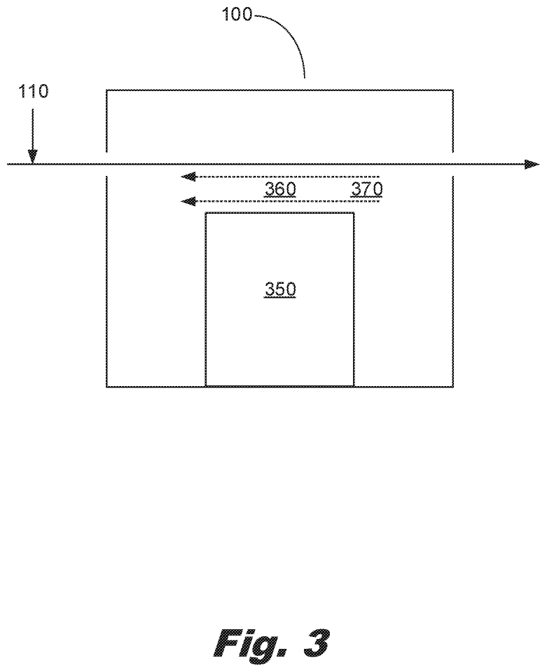

FIG. 3 shows an example of a system (100) for drying printing fluid consistent with this specification. The system (100) includes: a web (110) moving in a first direction; a support (350) under the web, the support (250) separated from the web (110) by a gap (360), the gap (360) having a height and a length; and a counter-current air flow (370) along the length of the gap (360) in a direction counter to the first direction.

The support (350) provides a lower surface below the gap (360). The support (350) may contact the web (110), for example, along the edges of the web (110). The support (350) may not contact the web (110). The support (350) may provide and/or direct airflow to separate the web (110) from the support (350).

The gap (360) separates the web (110) from the support (350). The gap (360) has a length in the direction of motion of the web (110), i.e., the first direction. The gap (360) has a height defining the separation between the support (350) and the web (110). The gap (350) has a width which is into the plane of the FIG. 3. The width parallels a width of the web (110). In an example, the gap (360) is less than 1 millimeter in height. The gap (360) may be less than a height of a boundary layer of the web (110).

The air flow (370) moves air through the gap (360) counter to the motion of the web (110). Directing the air flow (370) against the motion of the web (110) may prevent the developed boundary layer of the web (110) from passing through the gap (360).

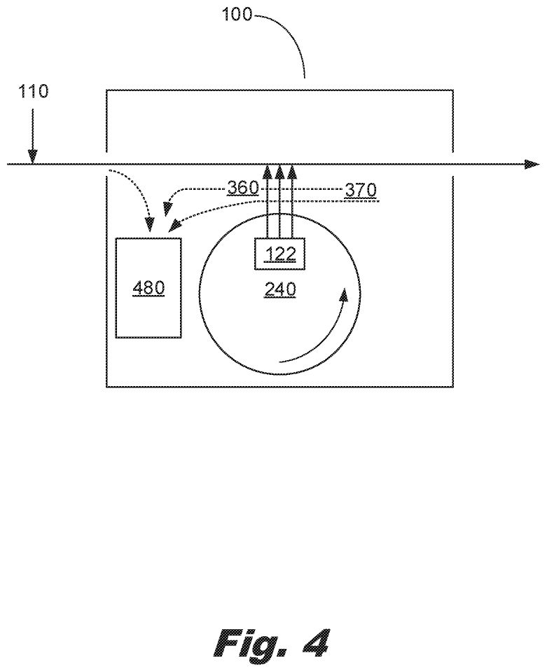

FIG. 4 shows an example of a system (100) for drying printing fluid consistent with this specification. The system (100) includes: a web (110) moving in a first direction; an air-bearing (240) under the web; the air-bearing (240) separated from the web (110) by a gap (360); a counter-current air flow (370) along a length of the gap (360) in a direction counter to the first direction; an electromagnetic radiation source (122) applying electromagnetic radiation to the web in the gap (360); and a trap (480) located on an upstream side of the web (110) of the gap and the trap (480) including a lower pressure to collect material extracted from the web (110).

The air-bearing (240) may rotate such that a surface of the air-bearing (240) in the gap (360) is moving counter to the first direction. The air-bearing (240) may be static. Static air-bearings may have different vent hole patterns as discussed above to shape the pressure field in the gap. A rotating air-bearing (240) may have radial uniformity in the vent hole patterns, density, and/or diameters. The rotating air-bearing (240) may be laterally uniform and/or may vary laterally in vent hole patterns, density and/or diameters. For example, the vent holes may be larger near the edges of the air-bearing (240) to direct flow away from the edge of the web (110).

The system (100) may prevent pass of 80% of material forming the boundary layer of the web (110) through the gap (360). The system (100) may prevent passage of 90% of material forming the boundary layer of the web (110) through the gap (360). The system (100) may prevent passage of more than 95% of material forming the boundary layer of the web (110) through the gap (360). The percentage may be based on mass of the material in the boundary layer.

The electromagnetic radiation source (122) may be a microwave source (120). The electromagnetic radiation source (122) may be an ultraviolet (UV) source. The electromagnetic radiation source (122) may be an infrared (IR) source.

The electromagnetic radiation source (122) may be located inside the air-bearing (240). The air-bearing (240) and/or a portion thereof may be transparent to microwave and/or UV electromagnetic radiation. Waste heat from the electromagnetic radiation source (122) may heat air passing through the air-bearing (240). The air-bearing (240) may be static. The air-bearing (240) may rotate.

The trap (480) may be located upstream of the gap (350). The trap (480) includes a low pressure. The low pressure draws the material of the boundary layer of the web (110). The material of the boundary layer is prevented from passing through the gap (360). This increases removal rate of the solvent from the printing fluid. The trap (480) also serves to collect the solvent and other materials extracted from the printing fluid. This reduces contamination of other portions of the system (100) and/or the area with printing fluid. Some printing fluid formulations may be corrosive and/or reduce the lifetime of parts of a printing system. Some printing fluids may contain water, ethanol, fatty materials, and/or silicones which may present a slip and fall hazard near systems using them, for example, when the materials deposit on nearby floors. The material collected by the trap (480) may be disposed and/or recycled. The trap (480) may facilitate forming and controlling the air flow (370) through the gap (360).

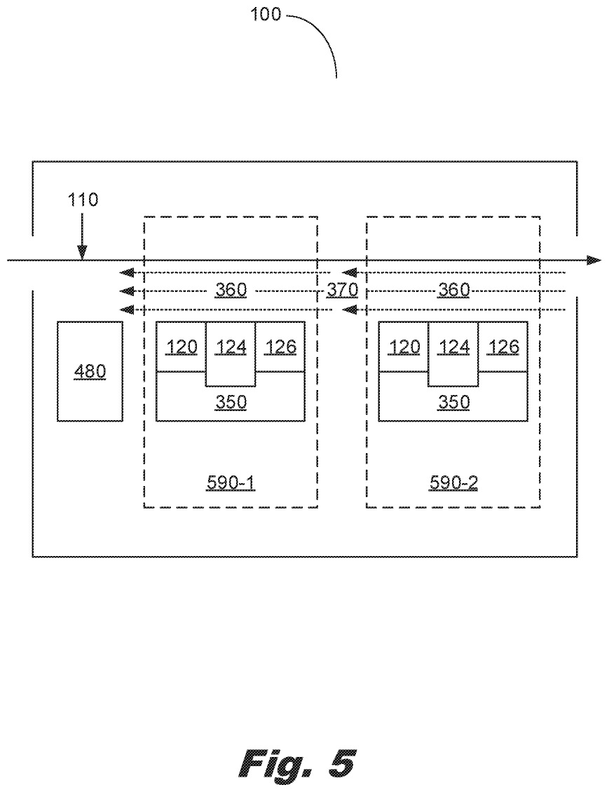

FIG. 5 shows an example of a system (100) for drying printing fluid consistent with this specification. This system (100) includes: a web (110) moving in a first direction, the web (110) including media and a printing liquid; a plurality of identical modules (590), each module (590) including: a support (350) located under the web (110); an area between the support (350) and the web (110) forming a gap (360) with a height and length, wherein: the height being the separation of the support (350) and the web (350), the length being in the first direction; and an air flow (370) flowing the length of the gap (360), the air flow (370) moving counter to the first direction; a microwave source (120) to apply microwaves to the web (110); an ultraviolet (UV) source (124) to apply ultraviolet light to the web (110); an infrared (IR) source (126) to apply infrared light to the web (110); and a reduced-pressure trap (480) on an upstream side of the gap (360) of a first module (590-1) of the plurality of modules (590), the trap (480) collecting material released from the web (110).

The system (100) is a system (100) for drying a printing web (110). The system (100) may be part of a larger device such a printer and/or a press. The system (100) uses the interchangeable modules (590) to provide a treatment profile to the web (110), The modules (590) include a microwave source (120) and other elements which are used to finish printing fluid on media which form part of the web (110), The printing fluid may be crosslinked by UV radiation. The print fluid by be finished by extracting a solvent, such as water, from the printing fluid. The printing fluid may be finished by heating and/or pressure.

The module (590) is one a plurality of identical modules (590). The modules (590) may be interchangeable. The parameters applied to the modules (590) may be different to provide a desired heating/drying profile for printing fluid associated with the web (110). The amount of power provided to the microwave source (120), IR source (124), and/or UV source may vary between the modules depending on the amount of printing fluid in a given portion of the web. For example, areas with low amounts of printing fluid, e.g., a title page, may receive lower amounts of electromagnetic radiation from the microwave (120), UV (128), and/or IR sources (124), In contrast, areas with full color images may receive greater amounts of electromagnetic radiation. The type of printing fluid may also impact how much and which electromagnetic radiation sources (122) are used. For example, printing fluids with a high water content may be more amenable to microwaves and printing fluids using other solvents may use UV and/or IR electromagnetic radiation.

The infrared (IR) source (124) provides infrared radiation which is absorbed by the web (110), including by printing fluid on media in the web (110). The IR source (124) may apply the radiation directly to the side of the web (110) having the printing fluid. The IR source (124) may apply IR to the opposite side of the web (110), heating the web (110). The IR source (124) may be located in an air-bearing (240) and used to heat the air used to form the bearing. The IR source (124) may direct infrared electromagnetic radiation onto a lower surface of the web (110) in a gap (360) between the web (110) and the support (350).

The ultraviolet (UV) source (126) may be located inside a UV-transparent support (350). The UV source (126) may be located inside a UV-transparent air-bearing (240). Waste heat from the UV source (126) may heat air used in the air-bearing (240), reducing the need to preheat the air supplied to the air-bearing (240). The UV source may be partially shielded to focus the UV emissions. The system (100) may include a cage (130) to limit the emission of UV from the module (590) and/or system (100).

The term transparent as used in this specification does not imply and/or require 100 percent permeability to the type of radiation, A material and/or structure is transparent if it allows a majority of the electromagnetic radiation of the described type (e.g., U.V., microwave) to pass through the material and/or structure. In an example, a transparent material allows 51%, 70%, 90%, and/or 95% of the type of electromagnetic radiation. Transparency does not imply anything about permeability and/or absorption of other types of radiation; for example, glass is transparent to visible light but strongly absorbs infrared light.

In an example, each module (590) includes an associated trap (480) to collect extracted material. Each module (590) may have an associated air feed to provide air to flow through the associated gap (360).

It will be appreciated that, within the principles described by this specification, a vast number of variations exist. It should also be appreciated that the examples described are only examples, and are not intended to limit the scope, applicability, or construction of the claims in any way.

What is claimed is:

1. A system comprising:
a web moving through the system, the web comprising media and a printing liquid;
a microwave source to apply microwaves to the web and printing fluid; and
a cage to reduce emission of microwaves from the system.

2. The system of claim 1, further comprising a microwave-transparent air-bearing encompassing the microwave source.

3. A system comprising:
a web moving in a first direction;
a support under the web, the support separated from the web by a gap, the gap having a height and a length; and
a counter-current air flow along the length of the gap in a direction counter to the first direction.

4. The system of claim 3, wherein the support is an air-bearing.

5. The system of claim 3, wherein the gap is less than 1 millimeter in height.

6. The system of claim 3, wherein the gap is less than a height of a boundary layer of the web.

7. The system of claim 3, further comprising a trap, the trap located on an upstream side of the web of the gap and the trap comprising a lower pressure to collect material extracted from the web.

8. The system of claim 3, wherein the support rotates such that a surface of the support in the gap is moving counter to the first direction.

9. The system of claim 3, wherein the system prevents passage of 90% of material comprising a boundary layer of the web through the gap.

10. The system of claim 3, further comprising an electromagnetic radiation source applying electromagnetic radiation to the web in the gap.

11. The system of claim 10, wherein the electromagnetic radiation source is a microwave source.

12. The system of claim 10, wherein the electromagnetic radiation source is located inside the support.

13. The system of claim 12, wherein the support is an air-bearing and waste heat from the electromagnetic radiation source heat air passing through the air-bearing.

14. A system comprising:
a web moving in a first direction, the web comprising media and a printing liquid;
a plurality of identical modules, each module comprising:
a support located under the web, an area between the support and the web forming a gap with a height and length, wherein:
the height being the separation of the support and the web,
the length being in the first direction, and
an air flow flowing the length of the gap, the air flow moving counter to the first direction;
a microwave source to apply microwaves to the web;
an ultraviolet (UV) source to apply ultraviolet light to the web;
an infrared (UR) source to apply infrared light to the web; and
and a reduced-pressure trap on an upstream side of the gap of a first module of the plurality of modules, the trap collecting material released from the web.

15. The system of claim 14, wherein different modules of the plurality of modules apply different amounts of power individually to air supply, counter rotational speed, and the microwave sources of the respective modules.
